(19) United States
(12) Patent Application Publication
(10) Pub. No.: US 2018/0190022 A1
(43) Pub. Date: Jul. 5, 2018

(54) DYNAMIC DEPTH-BASED CONTENT CREATION IN VIRTUAL REALITY ENVIRONMENTS

(71) Applicants: Nadav Zamir, Raanana (IL); Barak Hurwitz, Kibbutz Alonim (IL); Daniel Piro, Santa Clara, CA (US); Kobi Nistel, Haifa (IL); Amit Shahar, Sunnyvale, CA (US); Dimitri Diakopoulos, Santa Clara, CA (US)

(72) Inventors: Nadav Zamir, Raanana (IL); Barak Hurwitz, Kibbutz Alonim (IL); Daniel Piro, Santa Clara, CA (US); Kobi Nistel, Haifa (IL); Amit Shahar, Sunnyvale, CA (US); Dimitri Diakopoulos, Santa Clara, CA (US)

(21) Appl. No.: 15/394,996

(22) Filed: Dec. 30, 2016

(51) Int. Cl. G06T 19/00; G06F 3/0346

(52) U.S. Cl. CPC G06T 19/006; G06F 3/0346

(57) ABSTRACT

Various systems and methods for generating and outputting dynamic depth-based content in a virtual reality (VR) environment are described. For example, a technique for generating location-customized content in VR may be implemented by electronic operations that: detect an object from image data of a real-world environment; identify the real-world location of the object relative to a viewing position with a VR device; identify a corresponding virtual location for a selected virtual object; and display the virtual object at the corresponding virtual location in VR. The image data may be generated from an image sensor and a depth sensor that captures three-dimensional aspects of the real-world environment. Based on the type and characteristics of the real-world object, a corresponding virtual object may be presented and interacted with, to allow a human user to avoid real-world obstacles or other objects during a VR session.

### TECHNICAL FIELD

Embodiments described herein generally relate to the generation and display of graphical content by personal electronic devices, and in particular, to the dynamic generation and display of graphical content in a virtual reality environment that is output to a human user with a virtual reality display device.

### BACKGROUND

A variety of virtual reality (VR) devices and applications have been steadily developed and released to consumers. Many types of existing VR devices, such as specialized VR headset units connected to a computer system, are tethered to computer systems and provide only three degrees of freedom (DOF). Such devices provide a user with natural representation and control of orientation, but not movement, while the user operates the VR device.

Newer versions of VR headsets have been developed that enable six DOF (6DOF) in a VR environment for a human user. For example, some existing approaches allow physical movement by the human user who wears a specialized VR headset, with the use of external trackers that are scattered around the user's real-world environment. Such external trackers are used to observe the user's location in the real world and to transmit the location back to the user's VR headset device or tracking system. However, use of this approach means that the user can only move in a predefined, constrained environment with specialized tracking equipment.

When a user wears a VR headset and is engaged within the virtual world, the user will often become unaware of physical constraints in the real world. Thus, a human who utilizes a 6DOF headset may encounter constraints such as walls, furniture, and even safety hazards as they move within the real-world environment. In the virtual world, however, the user may expect to be freely able to move within the virtual space.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings in which:

FIG. 1 illustrates a diagram of devices and systems used for enabling location-contextual content in a virtual reality environment, according to an example;

FIGS. 2 and 3 illustrate a virtual reality view and a real-world view respectively for generating output of a virtual reality environment, according to an example:

FIG. 4 illustrates a further comparison of virtual reality views and real-world views used with a virtual reality environment, according to an example;

FIG. 5 illustrates a flowchart depicting operations for generating and updating contextual content in a virtual reality environment, using captured image information, according to an example;

FIG. 6 is a flowchart illustrating a method of generating location-customized content in a virtual reality environment, in response to a detected real-world obstacle, according to an example:

FIG. 7 illustrates a block diagram of components in a system for generating and outputting contextual content in a virtual reality environment, according to an example; and

FIG. 8 illustrates a block diagram for an example electronic processing system upon which any one or more of the techniques (e.g., operations, processes, methods, and methodologies) discussed herein may be performed, according to an example.

### DETAILED DESCRIPTION

In the following description, methods, configurations, and related apparatuses are disclosed for the generation and presentation of dynamic content in a virtual-reality environment based on real-world characteristics. In particular, the techniques discussed herein are relevant to the use of virtual reality devices that enable fully or partially unconstrained movement by a human user, such as a virtual reality device providing an output based on six degrees of freedom (6DOF) in movement for a human user. Various device-based and system-based techniques for identifying, generating, updating, and modifying the display and application of contextual virtual reality content are disclosed herein, including the display and modification of virtual reality objects and scenarios to match real-world constraints encountered with 6DOF. Further, the presently disclosed techniques may be used to model and update a virtual environment to more closely match the characteristics (and limitations) surrounding a virtual reality user in a real-world environment.

As virtual reality has developed into new applications and form factors, the different capabilities and physical world limitations of virtual reality sessions have been magnified. One important use case of virtual reality relates to environments that can be navigated using 6DOF display devices, to allow the user to move in real space and to translate the user's movement in the real world in any of six directions to movements in the virtual world. This use case has not been addressed with existing approaches that focus only on basic changes to orientation (e.g., how the user's viewpoint is determined and updated in a virtual space) and localization (e.g., how the user's location and movement is enabled in some space) during the virtual reality experience. Further, although some existing approaches are able to present a visualization or representation of some real-world objects in the virtual environment, such objects often interrupt the interactive setting of the virtual world and cannot be naturally interacted with.

As discussed in the following examples, the presently disclosed techniques may be implemented with various forms of virtual reality devices that support orientation and localization with 6DOF navigation within a virtual environment. As one non-limiting example, a virtual reality headset may be used to provide movement that is unconstrained in space, through use of 6DOF movement, with the presentation of objects in the virtual environment that correspond to real-world objects. As another non-limiting example, a computing device (including a computing device placed in a virtual reality headset apparatus) may be used to generate and update the display of a virtual reality input, in response to detected movement of the human user through space. In either example, the presentation of objects in the virtual environment may be generated and updated to correspond to real-world objects including obstacles or hazards. The presentation of these objects in the virtual environment may be updated, animated, and removed based on natural movement of the user's viewing position in the real-world environment.

Virtual reality headsets and virtual reality-simulation devices that allow 6DOF movement for a virtual reality environment may raise movement, orientation, and location issues for the human user. In particular, when a user is engaged within the virtual world, the user may become unaware of the limits of the real world. When moving to other areas or spaces, there are likely to be constraints from the user's real environment (e.g., furniture, walls, natural features, etc.) that differ from the constraints that are portrayed in the virtual reality environment. This can cause disruption or even a serious safety incident with the human user if the real-world features are encountered. The techniques discussed herein include display and processing techniques to perform a correlation, match, and output of virtual constraints that match or correspond to the real world constraints. Such constraints can be introduced, removed, and updated in the virtual world—dynamically as the user moves, adjusting the virtual content and fitting it to the real world.

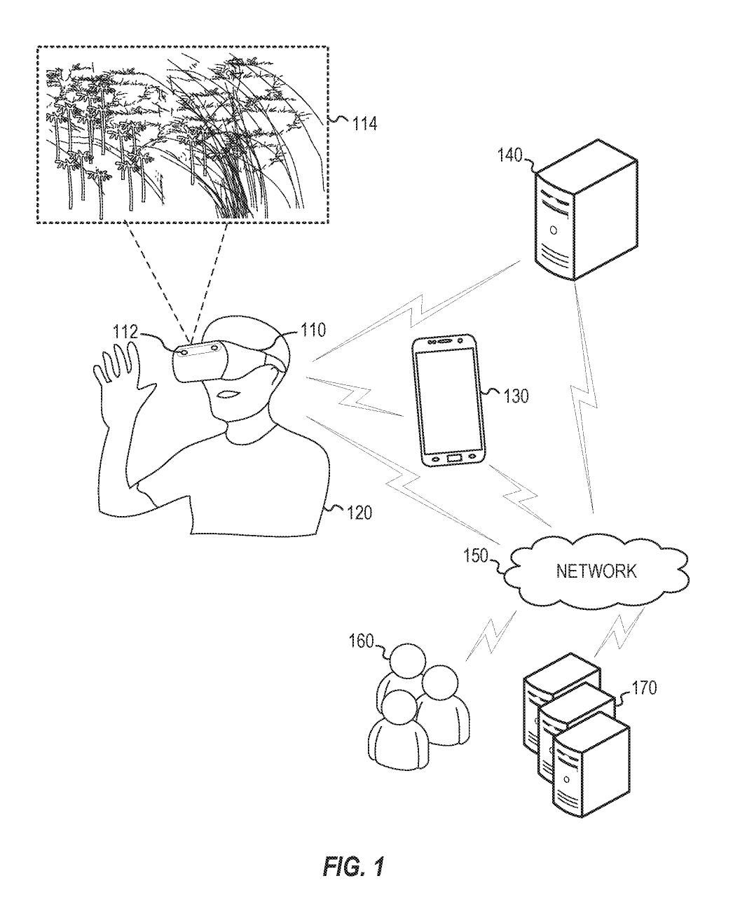

FIG. 1 illustrates example devices and systems used for enabling location-contextual content in a virtual reality environment. The following examples specifically describe use cases involving virtual reality headset devices, such as through the use of a headset device enabling movement and orientation in a virtual world with six degrees of freedom, which is controlled in response to the real-world movement of the human user. The integration of the following example features may be provided other types and form factors of virtual reality output devices, including goggles, glasses, shells, and the like. Further, it will be understood that the following example features may be generated from display processing actions of a computing device, such as a standalone computer system, a smartphone, a wearable device, a server system, or the like.

FIG. 1 specifically illustrates the use of a virtual reality device 110 as a head-mounted display 110 worn by a human user 120. In an example, the head-mounted display 110 includes electronic operational circuitry to detect, generate, and display contextual content in a virtual reality environment, such as may be provided from a standalone virtual reality headset device with an integrated screen, processing circuitry, and sensors. In another example, the head-mounted display 110 may be provided from the integration of a mobile computing device with a screen that is placed into a field of view for the human user 120. This may occur in a virtual reality device shell where the mobile computing device (such as mobile computing device 130) provides the virtual reality output directly from an integrated screen. Also in some examples, the head-mounted display 110 may be communicatively coupled (e.g., via wireless or wired connection) to an external computing device 140 (e.g., a gaming console, desktop computer, mobile computer) or the mobile computing device 130 when in operation. It will be understood that the present techniques may be integrated into a variety of form factors and processing locations that generate a virtual reality display. Further, the presently described features may also be applicable to other forms of computing devices that operate independently and which provide virtual reality, simulated virtual reality, augmented reality, or like user-interactive devices.

The head-mounted display 110 (e.g., a standalone virtual reality headset device) may include a display screen (not directly shown) for outputting personal virtual reality scene viewing, such as through one or more displays (e.g., liquid crystal display (LCD), light emitting diode (LED), organic light emitting diode (OLED) or screens), and one or more cameras (e.g., camera 112) used for capturing image data from a real-world environment that surrounds the human user 120. For example, a goggle display system provided by the head-mounted display 110 may use two LCDs as stereoscopic displays. In an example, the goggle display system creates an enclosed space when placed on the head of the human user 120, to simulate immersive effects for a virtual environment via the output of the stereoscopic displays.

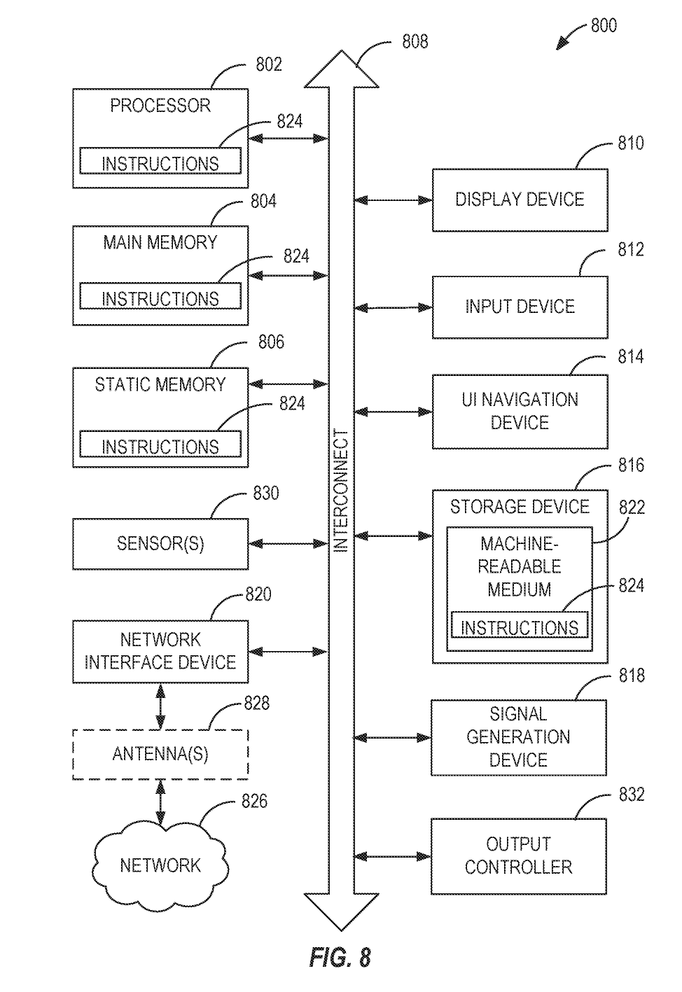

The head-mounted display 110 (or its connected computing devices 130, 140 used to provide the display) may also include display hardware such as a graphics rendering pipeline, a receiver, and an integrator. These components may be implemented in computer hardware, such as that described below with respect to FIG. 8 (e.g., processor, circuitry, FPGA, etc.). The graphics rendering pipeline may include components such as a graphics processing unit (GPU), physics engine, shaders, etc., used to generate the output of a scene of the virtual environment to the human user 120, for example, via a display screen located in the head-mounted display 110.

In an example, the head-mounted display 110 changes an orientation and localization of virtual reality content as the result of sensor data, collected from one or more sensors such as sensors integrated in the head-mounted display or other connected electronic devices (e.g., the mobile computing device 130, wearable devices, or the like). In some examples, the sensor data set includes data for a position of a body part of the user (e.g., a hand). The position and movement of the head-mounted display 110 may be derived from raw data such as accelerometer or gyrometer readings (e.g., from sensors included in the head-mounted display 110, or from the mobile computing device 130), that are subjected to a model to determine the position of the head-mounted display 110 or the human user 120. The raw data may also be processed or integrated into features of a position system (including features of a position system located external to the head-mounted display 110). As discussed herein, the virtual reality content may be further updated to identify objects detected via image data from one or more cameras (e.g., camera 112, located on a forward-facing portion of the head-mounted display 110). The one or more cameras may capture two-dimensional (RGB) data or three-dimensional (depth) data, or both, to identify objects or environmental conditions in the real-world environment of the user. For example, the one or more cameras may capture aspects of visible light, infrared, or the like.

FIG. 1 further depicts an example virtual reality scenario 114 that is generated for display by a screen of the head-mounted display 110 (e.g., via a built-in screen, or via a screen of an included mobile computing device 130). The head-mounted display 110 is configured to output an immersive graphical representation of the virtual reality scenario 114 to be perceived and interacted with by the human user 120, with characteristics of the virtual reality scenario 114 changing as the human user 120 changes location and orientation. As discussed below, this virtual reality scenario 114 may be updated to provide contextual output depending on real-world objects, features, and limitations. Specifically, in a fully immersive virtual reality environment, the user cannot see any portion of real-world objects (and may even be prevented from hearing or using other senses to perceive the real-world environment around the user). This fully immersive environment is in contrast to augmented reality or partially-immersed virtual reality settings that allow the user to see objects in the real-world environment around the user.

In some examples, the virtual reality scenario 114 output by the head-mounted display 110 may be affected by additional data processing operations performed at the external computing device 140, or the mobile computing device 130, including the detection of other environment or sensed characteristics (e.g., determined by sensors or input of the mobile computing device 130). In still other examples, the virtual reality scenario 114 output by the head-mounted display 110 may be affected by data processing operations performed by remote users 160 (e.g., users operating respective headset devices) or remote computing systems 170 (e.g., data processing servers). The remote users 160 and remote computing systems 170 may be connected to the head-mounted display 110 directly via a network 150 or indirectly via communications with the mobile computing device 130 or an external computing device 140. For example, the remote users 160 may affect the virtual reality display through interactive virtual reality games or interaction sessions hosted by the remote computing systems 170.

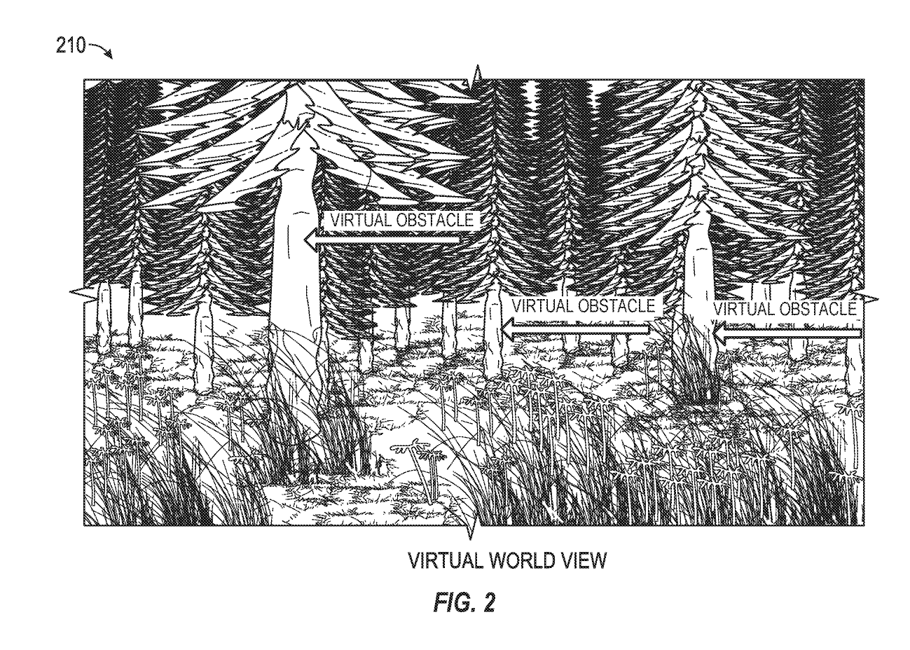

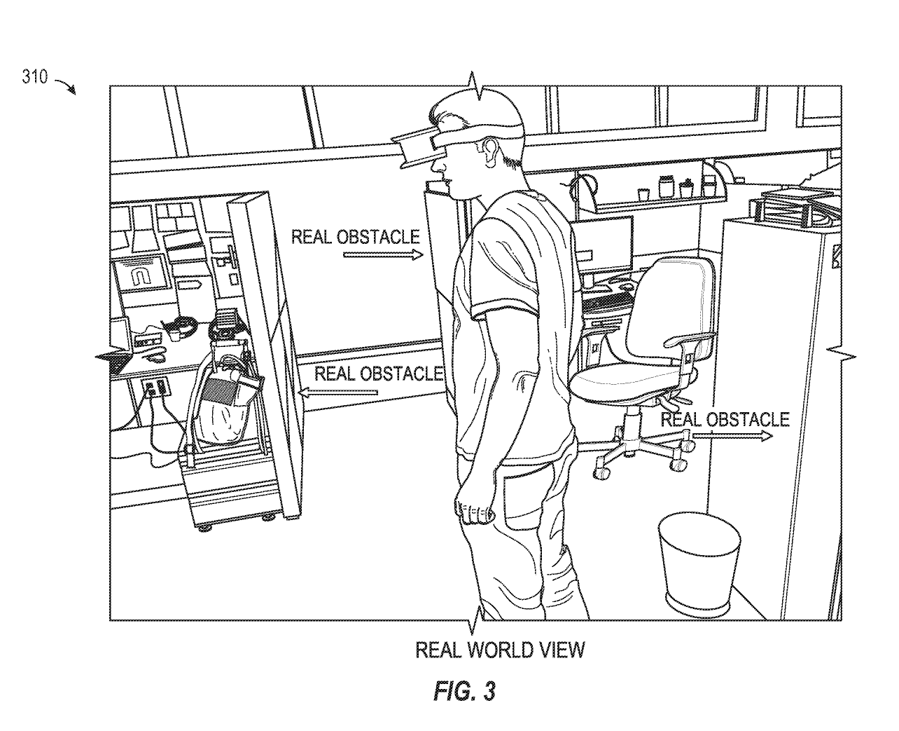

FIG. 2 and FIG. 3 provide respective illustrations of a virtual reality environment 210 and a real-world environment 310 used for generating output of an example virtual reality scenario, such as in a virtual reality environment implementing the contextual data processing techniques discussed herein. The following examples specifically illustrate the navigation of a human user within a virtual reality environment that depicts an outdoor landscape, and the movement of the human user within an indoor, real-world environment (an office).

In an example further discussed below, the virtual reality environment 210 is updated with constraints (namely, virtual obstacles) that correspond to real-world objects, to provide a seamless and intuitive virtual reality experience. For example, in connection with the virtual reality environment 210, suppose the user is immersed in a virtual experience of standing in a forest, which is output from the display of the virtual reality device. Some of the constraints that are presented in this virtual reality view may include boundaries, trees, and other objects, which are located in the virtual environment (e.g., at a distance from the user). These virtual objects are generated to correspond to constraints to impose in real-world environment, namely, to prevent a user from encountering indoor hazards, obstacles, and other objects that exist in real-life.

The examples of FIG. 3 depict the constraints that are present in the real-world environment 310 during the presentation and use of the virtual reality environment 210. In the real-world environment 310, the user may encounter constraints (such as walls, furniture, trees, rocks, elevation changes) that would interrupt or prevent the user from unhindered movement when wearing the virtual reality device. In an example, the content generation techniques discussed herein operate to identify such real-world objects and characteristics, using image data of the real-world objects. This image data is processed to display virtual-world objects and characteristics that prevent a user from colliding with the real-world objects. As an example, in the virtual reality environment 210, presented in a forest, large trees may be placed in certain locations to prevent the user's real-world movement from causing the user to stumble into a wall.

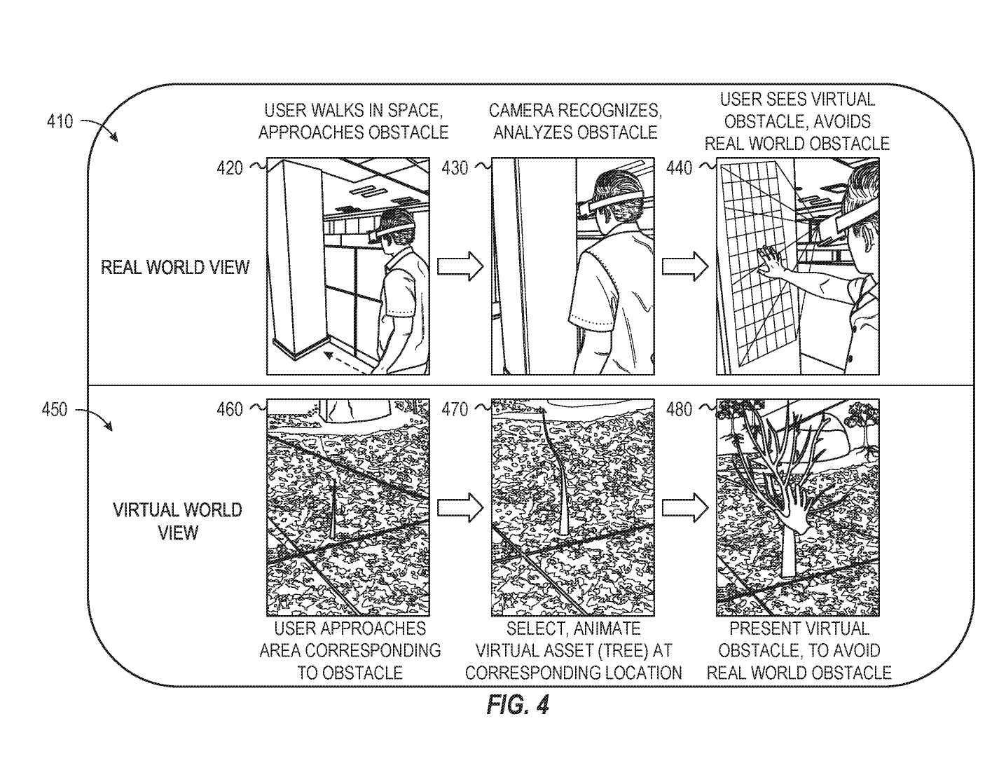

FIG. 4 illustrates a further comparison of example real-world views 410 and virtual reality views 450 provided with a virtual reality environment. As shown, a sequence of three points in time are depicted with each of the views 410, 450, as a human user begins to interact with a virtual object in the virtual reality environment that corresponds to a real-world object. It will be understood that the following interaction with a particular virtual object (and portrayal of a corresponding real-world object) may involve other types of interaction, and the following is provided as an illustrative example.

In the real-world view 410 (depicted in scenario 420), the human user wears a virtual reality headset, and commences movement to walk in the real-world space as he approaches a particular object (a real-world obstacle). The characteristics and location of this real-world obstacle is detected from image data, such as two-dimensional (RGB) and three-dimensional (depth) data. In the virtual world view (depicted in scenario 460), as the movement of the user causes the landscape of the virtual world to change, the display of the virtual environment is also changed to add the presentation of a virtual object (portrayed as a virtual-world obstacle). The presentation of the virtual object is provided at a location in the virtual environment (e.g., at a determined distance away from the portrayed perspective) that corresponds to the location in the real-world environment (e.g., at a determined real-world distance away from the human user). This obstacle may appear at a far point in the distance, for example, depending on the proximity of the human user to the real-world object, and any necessary perspective or orientation changes in the virtual environment.

Next, the human user continues movement in both the real world and the virtual world, and the camera recognizes and analyzes further characteristics of the real-world obstacle from image data. For example, the characteristics of the real-world obstacle may be recognized to identify a particular type, shape, class, or other feature of the real-world obstacle (depicted in scenario 430, for detection of a wall). In response to the user movement towards the real-world obstacle, a particular virtual object (an asset) corresponding to the obstacle is selected and presented (depicted in scenario 470). In an example, as the user continues to approach the location corresponding to the virtual object, certain effects may occur, such as may be presented with animation or other changes in features. In some examples, a predefined area may be defined around (or proximate to) the location corresponding to the virtual object, with the display, updating, or removal of the virtual object being caused when the user crosses the boundary of the predefined area.

Finally, the scenarios portray an interactive response by the human user, as the human user observes and responds to the virtual obstacle with a real-world action (e.g., a gesture) (depicted in scenario 440). The virtual obstacle is expanded, presented, and updated in the virtual environment (depicted in scenario 480) to prevent the human user from walking into the real-world obstacle. In a further example, the human user may perform interaction with the virtual world obstacle to assist navigation or interaction in the real or virtual world. For example, a user may hold out his or her hand in the real world, which is detected in the virtual world to cause a certain display effect of the virtual obstacle, such as animation. This may be accompanied by a status message, warning, or other visual or sensory feedback that corresponds to an attribute of the real-world obstacle or the virtual world obstacle that is portrayed.

In other examples, other forms of objects may be generated and displayed to synchronize to the characteristics of a real world object. For example, an elevation change (e.g., a descending stairway, etc.) that is located in front of the user may be presented with a view of a “hole” within the virtual environment. In another example, a safety hazard (e.g., furniture, water, an unsafe location) can be presented in the virtual world as fire, a walled off area, or other characteristic, to discourage the user from approaching or encountering the safety hazard. Other variations to the type, format, and use of the virtual obstacle may also be presented in the virtual environment.

In further examples, the display techniques discussed herein may also be used to seamlessly present “reverse synchronization” of obstacles in the virtual world. In such scenarios, the user can move in the virtual world to encounter and interact with a virtual obstacle, even though there is no real obstacle at that location in front of the user. As an example, a user may walk in a virtual forest containing many trees and rocks that are presented as virtual obstacles, even though the real world may not contain an obstacle at the corresponding location. Logic, rules, and multimedia effects can be used to dynamically remove the virtual obstacles (lighting a tree on fire, causing an earthquake to move rocks, etc.) to encourage user movement in some direction as the real world allows and as the virtual experience may require.

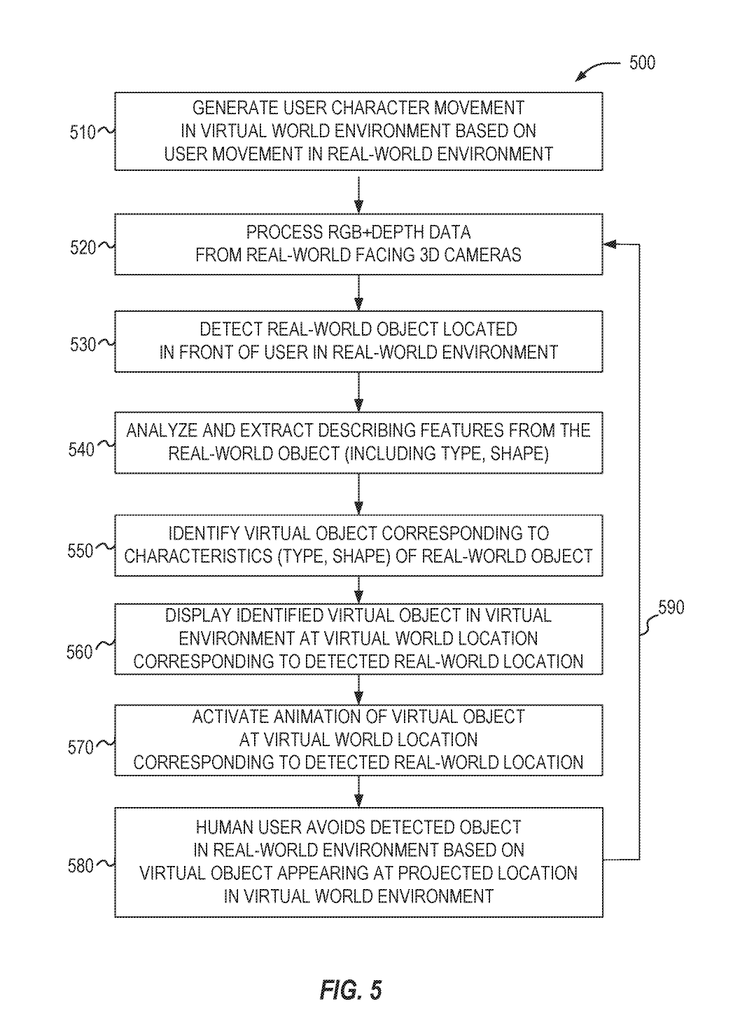

FIG. 5 illustrates a flowchart 500 depicting operations for generating and updating contextual content in a virtual reality environment, using captured image information. The operations of the flowchart 500 include the generation of user character movement in a virtual world environment, which corresponds to movement of a human user in a real-world environment (operation 510). This user character movement may be portrayed in a first person or second person perspective, including from the perspective of an avatar or other virtual character (including a non-human character). For example, the user character movement may correspond to the movement of a virtual reality device in any of 6DOF (including forward/backward, up/down, and left/right movements).

The flowchart 500 further depicts processing operations that are performed for detecting and identifying real-world objects. In an example, the real-world objects may be identified through the processing of data from one or more 3D cameras that map, detect, and collect RGB and depth image data (operation 520). Various detection and processing techniques may be performed on the RGB and depth image data to identify an object in a path of movement of the user (operation 530), such as to identify an object that presents an obstacle to human movement. Further, the detection and processing techniques may be used to predict the location of the object in the path of movement of the user, based on identified depth characteristics from the image data.

The RGB and depth characteristics of the image data may be further analyzed to identify features of the real-world object, such as a type, shape, class of the object (operation 540). In some examples, the image data may be analyzed with various image and object recognition or classification processes, to identify the particular object or class of object that corresponds to the real-world object. The identification of the characteristics (e.g., features, type, shape) of the real-world object may be used to identify a defined virtual object that corresponds to the characteristics (e.g., features, type, shape, or class) of the real-world object (operation 550).

The flowchart 500 further depicts processing operations that are performed with the virtual environment, such as location correlation operations that generate a display of the identified virtual object at a location in the virtual world to correspond to the detected real-world location (operation 560). In some examples, the processing operations may optionally include the presentation or change of new characteristics of the virtual object automatically or in response to user interaction in the virtual environment, such as an action that causes activation of an animation characteristic of the virtual object (operation 570). In some examples, the display or updating of the virtual object may be caused by the user moving into (our moving out of) a predefined area of the real-world environment, such as when the user moves into geofenced area or navigates across geolocation boundaries.

In response to the presentation, display, and interaction of the virtual object, the human user may avoid the detected object in the virtual environment (operation 580). As the human user navigates away from the detected object, the human user may navigate away towards another (a different) detected object, (operation 590) which is detected, displayed, and avoided using the previously-described process (repeating operations 520-580). In this fashion, the movement of the user in the real world can be synchronized with obstacle avoidance movements of the user in the virtual world, even as constraints are dynamically presented, emphasized, updated, and finally removed from the virtual world.

In some examples, the real-time synchronization is guided by the real environment that the user is in, which will push “events” to the virtual world output as the user moves around. As a result, the obstacles that are generated and presented in front of the user can be changed to be displayed at a certain distance, with a certain angle, and with certain display properties (e.g., to match the virtual environment). These properties may include high-level properties such as the size of an enclosing shape; techniques such as object recognition may be used to obtain more detailed properties of the respective objects. In some examples, depending on the characteristics of the intended virtual reality world, a set of assets (graphical objects) with different sizes and characteristics may be predefined for use in obstacle scenarios, for example, classes of additional trees and rocks to present in the case of a forest virtual world.

In a further example, animation features may be used to present a “sudden” appearance of a presented virtual obstacle, for example a tree that grows out of the ground, or a rock that emerges out in a small earthquake. As the human user approaches a real-world obstacle, the system analyses the type and properties of the obstacle indicated in the image data, and couples it with the most suitable asset. This asset may depend on the real object's properties and on the current available asset-group, which changes during the virtual world interaction. For example, if a user walks in a forest, the asset group may be adapted to contain trees and rocks; but as the user begins swimming in a lake, the group may be changed to vortexes that are more likely to appear in the middle of the lake then trees.

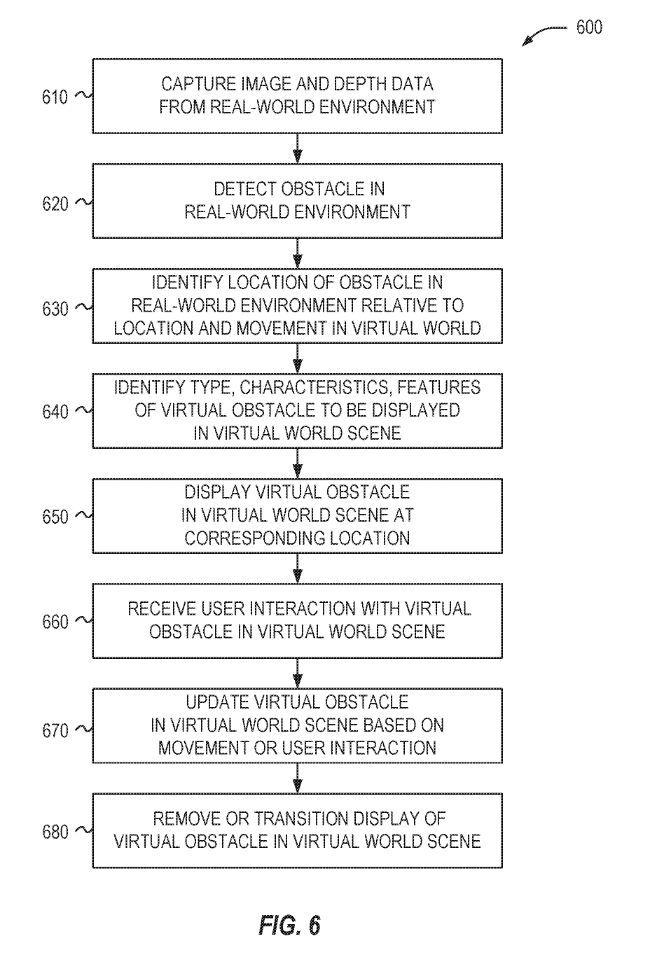

FIG. 6 is a flowchart 600 illustrating an example method of generating location-customized content in a virtual reality environment, in response to a detected real-world obstacle. The following operations of the flowchart 600 may be conducted by an electronic processing system (including a specialized computing system, virtual reality device, mobile computing device) adapted to generate or update a display of a virtual reality environment. It will be understood that the operations of the flowchart 600 may also be performed by other devices or a combination of devices, with the sequence and type of operations of the flowchart 600 potentially modified based on the other examples of interaction, control, and movement provided above.

The operations of the flowchart 600 include the capture of image and depth data from a real-world environment (operation 610), such as may be provided by input data of a two- and three-dimensional (RGB and Depth) camera device that faces the real-world environment. The image and depth data is then processed to detect an obstacle in the real-world environment (operation 620). In some examples, other forms of sensor data may be used to detect or identify an obstacle and the location of the obstacle relative to the perspective of the human user.

Further operations for processing the obstacle include the identification of the location of the obstacle in the real-world environment, relative to the location and movement of a human user in the virtual world environment (operation 630). For example, identification may include identifying the direction that the human user is traveling in the virtual world, relative to the obstacle (e.g., including forward/backward, up/down, and left/right movement of the human user), and the approximate speed and distance of movement from the human user to encounter the real-world obstacle. Further processing may include identifying the type, characteristics, or features of the real-world object, to identify a corresponding type, characteristics, or features of the virtual object to display at a corresponding location in the virtual environment (operation 640).

Based on the location of the identified obstacle, and the identified type, characteristics, or features of the obstacle, the virtual obstacle may be displayed in the virtual environment at the corresponding location (operation 650). User interaction with the virtual obstacle is further detected and received in the virtual environment (operation 660). In some examples, the virtual obstacle may be transitioned, faded (faded in or out), animated, morphed, or changed, based on the user interaction, human activity, or other aspects of the virtual environment (e.g., environment changes, rules of a game, activities of other users, etc.). Further, characteristics of the virtual obstacle may be updated in the displayed virtual world environments based on movement of the human user or user interaction with objects (operation 670). In response to the movement of the human user (e.g., away from the virtual obstacle), or other interaction of the human user, the display of the virtual obstacle may be removed or transitioned in the virtual environment (operation 680).

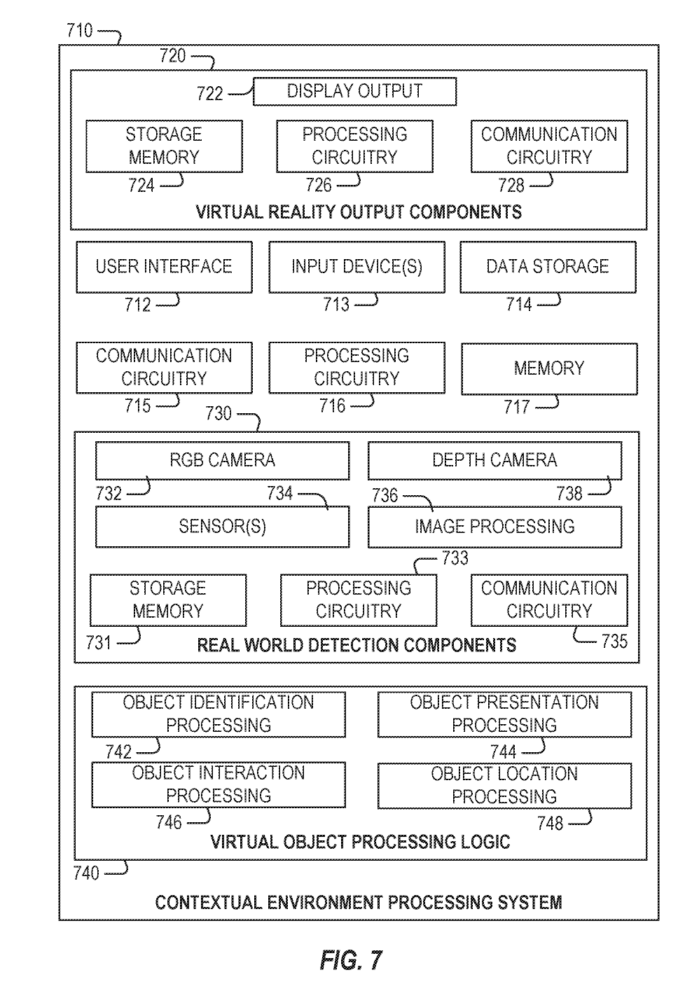

FIG. 7 illustrates a block diagram of components in an example system for generating and outputting contextual content in a virtual reality environment. As shown, the block diagram depicts a contextual environment processing system 710 that includes various electronic processing components (e.g., circuitry) that operates to generate location-customized content for a virtual reality environment output to a human user. It will be understood that additional electronic input, output, and processing components may be added with the contextual environment processing system 710, and that additional processing systems (such as external computing devices and systems) may be used in connection with the virtual reality environment updates described herein.

As shown, the contextual environment processing system 710 includes electronic components (e.g., circuitry) provided by virtual reality output components 720, real-world detection components 730, virtual object processing logic 740. Other electronic components may be added or integrated within the contextual environment processing system 710; likewise, other electronic components and subsystems from other devices (e.g., external devices) may be utilized for the operation of this processing system.

As an example, the virtual reality output components 720 may be embodied by features of a virtual reality headset that includes a display output 722 (e.g., stereoscopic display screen), with storage memory 724 and processing circuitry 726 to generate and output graphical content of a virtual reality environment, and communication circuitry 728 to receive graphical content to output via the display output 722. In some examples, the virtual reality output components 720 may be provided by a coupled computing device (e.g., a smartphone); in other examples, the virtual reality output components 720 are driven by use of an external computing device (e.g., a gaming console or personal computer).

The contextual environment processing system 710 is further depicted as including: circuitry to implement a user interface 712, e.g., to output an interactive display via the display output 722 or another user interface hardware device to control the virtual reality environment; input devices 713 to provide human input and interaction within the interactive display or other aspects of the virtual reality environment; data storage 714 to store image data, graphical content, rules, and control instructions for operation of the contextual environment processing system 710; communication circuitry 715 to communicate data (e.g., wirelessly) among the virtual reality output components 720, real-world detection components 730, and other components of the contextual environment processing system 710; and processing circuitry 716 (e.g., a CPU) and a memory 717 (e.g., volatile or non-volatile memory) used to host and process the operations and control instructions for operation of the contextual environment processing system 710.

The contextual environment processing system 710 is further depicted as including the real-world detection components 730, including a RGB camera 732, a depth camera 738, one or more sensors 734, image processing 736, storage memory 731 (e.g., to store data or instructions for operating the cameras 732, 738, the sensors 734, and the image processing 736), processing circuitry 733 (e.g., to process instructions for collecting image and sensor data via the cameras 732, 738 and the sensors 734), and communication circuitry 735 (e.g., to provide the collected image and sensor data to other aspects and devices of the contextual environment processing system, such as the virtual object processing logic 740).

The contextual environment processing system 710 is further depicted as including object processing features in the virtual object processing logic 740, such as may be provided by processing components for: object identification processing 742 (e.g., to identify characteristics of real-world objects), object presentation processing 744 (e.g., to generate a display of virtual world objects that corresponds to the characteristics of the real-world objects), object interaction processing 746 (e.g., to detect and receive human interaction with real world and virtual world objects), and object location processing 748 (e.g., to provide movement and perspective of virtual world objects that corresponds to the location of the real-world objects). In an example, the virtual object processing logic 740 may be provided from specialized hardware operating independent from the processing circuitry 716 and the memory 717; in other examples, the virtual object processing logic 740 may be software-configured hardware that is implemented with use of the processing circuitry 716 and the memory 717 (e.g., by instructions executed by the processing circuitry 716 and the memory 717).

FIG. 8 is a block diagram illustrating a machine in the example form of an electronic processing system 800, within which a set or sequence of instructions may be executed to cause the machine to perform any one of the methodologies discussed herein, according to an example embodiment. The machine may be a standalone virtual reality display system or component, a personal computer (PC), a tablet PC, a personal digital assistant (PDA), a mobile telephone or smartphone, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein. Similarly, the term “processor-based system” shall be taken to include any set of one or more machines that are controlled by or operated by a processor (e.g., a computer) to individually or jointly execute instructions to perform any one or more of the methodologies discussed herein.

Example electronic processing system 800 includes at least one processor 802 (e.g., a central processing unit (CPU), a graphics processing unit (GPU) or both, processor cores, compute nodes, etc.), a main memory 804 and a static memory 806, which communicate with each other via an interconnect 808 (e.g., a link, a bus, etc.). The electronic processing system 800 may further include a video display unit 810, an input device 812 (e.g., an alphanumeric keyboard), and a user interface (UI) control device 814 (e.g., a mouse, button controls, etc.). In one embodiment, the video display unit 810, input device 812 and UI navigation device 814 are incorporated into a touch screen display. The electronic processing system 800 may additionally include a storage device 816 (e.g., a drive unit), a signal generation device 818 (e.g., a speaker), an output controller 832 (e.g., for control of actuators, motors, and the like), a network interface device 820 (which may include or operably communicate with one or more antennas 830, transceivers, or other wireless communications hardware), and one or more sensors 826 (e.g., cameras), such as a global positioning system (GPS) sensor, compass, accelerometer, location sensor, or other sensor.

The storage device 816 includes a machine-readable medium 822 on which is stored one or more sets of data structures and instructions 824 (e.g., software) embodying or utilized by any one or more of the methodologies or functions described herein. The instructions 824 may also reside, completely or at least partially, within the main memory 804, static memory 806, and/or within the processor 802 during execution thereof by the electronic processing system 800, with the main memory 804, static memory 806, and the processor 802 also constituting machine-readable media.

While the machine-readable medium 822 is illustrated in an example embodiment to be a single medium, the term “machine-readable medium” may include a single medium or multiple media (e.g., a centralized or distributed database, and/or associated caches and servers) that store the one or more instructions 824. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and optical disks.

The instructions 824 may further be transmitted or received over a communications network 828 using a transmission medium via the network interface device 820 utilizing any one of a number of transfer protocols (e.g., HTTP). The term “transmission medium” shall be taken to include any intangible medium that is capable of storing, encoding, or carrying instructions for execution by the machine, and includes digital or analog communications signals or other intangible medium to facilitate communication of such software. Examples of communication networks include a local area network (LAN), a wide area network (WAN), the Internet, mobile telephone networks, plain old telephone (POTS) networks, and wide-area, local-area, and personal-area wireless data networks (e.g., Wi-Fi, Bluetooth, 2G/3G, or 4G LTE/LTE-A networks or network connections). Further, the network interface device 820 may perform other data communication operations using these or any other like forms of transfer protocols.

Embodiments used to facilitate and perform the techniques described herein may be implemented in one or a combination of hardware, firmware, and software. Embodiments may also be implemented as instructions stored on a machine-readable storage device, which may be read and executed by at least one processor to perform the operations described herein. A machine-readable storage device may include any non-transitory mechanism for storing information in a form readable by a machine (e.g., a computer). For example, a machine-readable storage device may include read-only memory (ROM), random-access memory (RAM), magnetic disk storage media, optical storage media, flash-memory devices, and other storage devices and media.

It should be understood that the functional units or capabilities described in this specification may have been referred to or labeled as components or modules, in order to more particularly emphasize their implementation independence. Such components may be embodied by any number of software or hardware forms. For example, a component or module may be implemented as a hardware circuit comprising custom very-large-scale integration (VLSI) circuits or gate arrays, off-the-shelf semiconductors such as logic chips, transistors, or other discrete components. A component or module may also be implemented in programmable hardware devices such as field programmable gate arrays, programmable array logic, programmable logic devices, or the like. Components or modules may also be implemented in software for execution by various types of processors. An identified component or module of executable code may, for instance, comprise one or more physical or logical blocks of computer instructions, which may, for instance, be organized as an object, procedure, or function. Nevertheless, the executables of an identified component or module need not be physically located together, but may comprise disparate instructions stored in different locations which, when joined logically together, comprise the component or module and achieve the stated purpose for the component or module.

Indeed, a component or module of executable code may be a single instruction, or many instructions, and may even be distributed over several different code segments, among different programs, and across several memory devices or processing systems. In particular, some aspects of the described process (such as image data processing) may take place on a different processing system (e.g., in an external computing device), than that in which input data is collected or the code is deployed (e.g., in a head mounted display including sensors and cameras that collect data). Similarly, operational data may be identified and illustrated herein within components or modules, and may be embodied in any suitable form and organized within any suitable type of data structure. The operational data may be collected as a single data set, or may be distributed over different locations including over different storage devices, and may exist, at least partially, merely as electronic signals on a system or network. The components or modules may be passive or active, including agents operable to perform desired functions.

Additional examples of the presently described method, system, and device embodiments include the following, non-limiting configurations. Each of the following non-limiting examples may stand on its own, or may be combined in any permutation or combination with any one or more of the other examples provided below or throughout the present disclosure.

Example 1 is a device for generating location-customized content in a virtual reality environment presented to a human user, the device comprising: processing circuitry; and a storage device to store instructions that, when executed by the processing circuitry, cause the device to perform operations to: detect, from image data of a real-world environment surrounding the human user, an object in the real-world environment; identify, from the image data, a real-world location of the object in the real-world environment, relative to a viewing position of the human user; identify a corresponding virtual location of the object for a scene of the virtual reality environment, wherein the corresponding virtual location is determined relative to the real-world location of the object in the real-world environment; cause display of a virtual object at the corresponding virtual location in the scene of the virtual reality environment; and cause update of the display of the virtual object in the scene of the virtual reality environment, wherein the display of the virtual object is updated to correspond to movement of the viewing position of the human user in the real-world environment.

In Example 2, the subject matter of Example 1 optionally includes camera circuitry, including an image sensor to capture the image data of the real-world environment.

In Example 3, the subject matter of Example 2 optionally includes the camera circuitry further including: a depth sensor to capture depth data of the real-world environment, wherein the real-world location of the object is identified using the depth data and the image data.

In Example 4, the subject matter of any one or more of Examples 1-3 optionally include the instructions further to cause the device to perform operations to: identify characteristics of the virtual object to be displayed in the virtual reality environment, wherein the characteristics of the virtual object correspond to characteristics of the object in the real-world environment that are detected from the image data.

In Example 5, the subject matter of Example 4 optionally includes the instructions further to cause the device to perform operations to: identify a type of the virtual object to be displayed in the virtual reality environment based on the identified characteristics of the virtual object; wherein the display of the virtual object includes displaying a graphical representation of the object that is selected from one of a plurality of types of objects corresponding to the type of the virtual object.

In Example 6, the subject matter of any one or more of Examples 4-5 optionally include the instructions further to cause the device to perform operations to: identify a shape of the virtual object to be displayed in the virtual reality environment based on the identified characteristics of the virtual object; wherein the display of the virtual object includes displaying a graphical representation of the object that is modified based on the identified shape.

In Example 7, the subject matter of any one or more of Examples 1-6 optionally include wherein the display of the virtual object at the corresponding virtual location is caused in response to the human user moving into a predefined area relative to the object in the real-world environment.

In Example 8, the subject matter of Example 7 optionally includes wherein the update of the display of the virtual object in the virtual reality environment is followed by removal of the display of the virtual object in the virtual reality environment, in response to the human user moving out of the predefined area relative to the object in the real-world environment.

In Example 9, the subject matter of any one or more of Examples 1-8 optionally include the instructions further to cause the device to perform operations to: transition a display of the virtual object to a display of a second virtual object, in response to user interaction with the virtual object in the virtual reality environment.

In Example 10, the subject matter of any one or more of Examples 1-9 optionally include the instructions further to cause the device to perform operations to: animate the display of the virtual object in the virtual reality environment, in response to user interaction with the virtual object in the virtual reality environment.

In Example 11, the subject matter of any one or more of Examples 1-10 optionally include wherein the device is a virtual reality headset, and wherein the virtual reality headset enables movement for the human user with six degrees of freedom.

In Example 12, the subject matter of any one or more of Examples 1-11 optionally include wherein the device is a computing device that generates the display of the virtual reality environment for output in a virtual reality headset.

Example 13 is at least one machine readable storage medium, comprising a plurality of instructions adapted for generating location-customized content in a virtual reality environment presented to a human user, wherein the instructions, responsive to being executed with processor circuitry of a machine, cause the machine to perform operations that: detect, from image data of a real-world environment surrounding the human user, an object in the real-world environment; identify, from the image data, a real-world location of the object in the real-world environment, relative to a viewing position of the human user; identify a corresponding virtual location of the object for a scene of the virtual reality environment, wherein the corresponding virtual location is determined relative to the real-world location of the object in the real-world environment; cause display of a virtual object at the corresponding virtual location in the scene of the virtual reality environment; and cause update of the display of the virtual object in the scene of the virtual reality environment, wherein the display of the virtual object is updated to correspond to movement of the viewing position of the human user in the real-world environment.

In Example 14, the subject matter of Example 13 optionally includes wherein the image data of the real-world environment is captured by an image sensor.

In Example 15, the subject matter of Example 14 optionally includes wherein the image data of the real-world environment includes depth data captured by a depth sensor, wherein the real-world location of the object is identified using the depth data and the image data.

In Example 16, the subject matter of any one or more of Examples 13-15 optionally include wherein the instructions further cause the machine to perform operations that: identify characteristics of the virtual object to be displayed in the virtual reality environment, wherein the characteristics of the virtual object correspond to characteristics of the object in the real-world environment that are detected from the image data.

In Example 17, the subject matter of Example 16 optionally includes wherein the instructions further cause the machine to perform operations that: identify a type of the virtual object to be displayed in the virtual reality environment based on the identified characteristics of the virtual object; wherein the display of the virtual object includes displaying a graphical representation of the object that is selected from one of a plurality of types of objects corresponding to the type of the virtual object.

In Example 18, the subject matter of any one or more of Examples 16-17 optionally include wherein the instructions further cause the machine to perform operations that: identify a shape of the virtual object to be displayed in the virtual reality environment based on the identified characteristics of the virtual object; wherein the display of the virtual object includes displaying a graphical representation of the object that is modified based on the identified shape.

In Example 19, the subject matter of any one or more of Examples 13-18 optionally include wherein the display of the virtual object at the corresponding virtual location is caused in response to the human user moving into a predefined area relative to the object in the real-world environment.

In Example 20, the subject matter of Example 19 optionally includes wherein the update of the display of the virtual object in the virtual reality environment is followed by removal of the display of the virtual object in the virtual reality environment, in response to the human user moving out of the predefined area relative to the object in the real-world environment.

In Example 21, the subject matter of any one or more of Examples 13-20 optionally include wherein the instructions further cause the machine to perform operations that: transition a display of the virtual object to a display of a second virtual object, in response to user interaction with the virtual object in the virtual reality environment.

In Example 22, the subject matter of any one or more of Examples 13-21 optionally include wherein the instructions further cause the machine to perform operations that: animate the display of the virtual object in the virtual reality environment, in response to user interaction with the virtual object in the virtual reality environment.

In Example 23, the subject matter of any one or more of Examples 13-22 optionally include wherein the machine is a virtual reality headset, and wherein the virtual reality headset enables movement for the human user with six degrees of freedom.

In Example 24, the subject matter of any one or more of Examples 13-23 optionally include wherein the machine is a computing device that generates the display of the virtual reality environment for output in a virtual reality headset.

Example 25 is a method of generating location-customized content in a virtual reality environment presented to a human user, the method comprising electronic operations performed with an electronic device, including: detecting, from image data of a real-world environment surrounding the human user, an object in the real-world environment; identifying, from the image data, a real-world location of the object in the real-world environment, relative to a viewing position of the human user; identifying a corresponding virtual location of the object for a scene of the virtual reality environment, wherein the corresponding virtual location is determined relative to the real-world location of the object in the real-world environment; displaying a virtual object at the corresponding virtual location in the scene of the virtual reality environment; and updating the display of the virtual object in the scene of the virtual reality environment, wherein the display of the virtual object is updated to correspond to movement of the viewing position of the human user in the real-world environment.

In Example 26, the subject matter of Example 25 optionally includes the electronic operations further including: capturing the image data of the real-world environment, using an image sensor.

In Example 27, the subject matter of Example 26 optionally includes the electronic operations further including: capturing depth data of the real-world environment, using a depth sensor, wherein the real-world location of the object is identified using the depth data and the image data.

In Example 28, the subject matter of any one or more of Examples 25-27 optionally include the electronic operations further including: identifying characteristics of the virtual object to be displayed in the virtual reality environment, wherein the characteristics of the virtual object correspond to characteristics of the object in the real-world environment that are detected from the image data.

In Example 29, the subject matter of Example 28 optionally includes the electronic operations further including: identifying a type of the virtual object to be displayed in the virtual reality environment based on the identified characteristics of the virtual object; wherein the display of the virtual object includes displaying a graphical representation of the object that is selected from one of a plurality of types of objects corresponding to the type of the virtual object.

In Example 30, the subject matter of any one or more of Examples 28-29 optionally include the electronic operations further including: identifying a shape of the virtual object to be displayed in the virtual reality environment based on the identified characteristics of the virtual object; wherein the display of the virtual object includes displaying a graphical representation of the object that is modified based on the identified shape.

In Example 31, the subject matter of any one or more of Examples 25-30 optionally include wherein the display of the virtual object at the corresponding virtual location is caused in response to the human user moving into a predefined area relative to the object in the real-world environment.

In Example 32, the subject matter of Example 31 optionally includes wherein the update of the display of the virtual object in the virtual reality environment is followed by removal of the display of the virtual object in the virtual reality environment, in response to the human user moving out of the predefined area relative to the object in the real-world environment.

In Example 33, the subject matter of any one or more of Examples 25-32 optionally include the electronic operations further including: transitioning the display of the virtual object to a display of a second virtual object, in response to user interaction with the virtual object in the virtual reality environment.

In Example 34, the subject matter of any one or more of Examples 25-33 optionally include the electronic operations further including: animating the display of the virtual object in the virtual reality environment, in response to user interaction with the virtual object in the virtual reality environment.

In Example 35, the subject matter of any one or more of Examples 25-34 optionally include wherein the electronic device is a virtual reality headset, and wherein the virtual reality headset enables movement for the human user with six degrees of freedom.

In Example 36, the subject matter of any one or more of Examples 25-35 optionally include wherein the electronic device is a computing device that generates the display of the virtual reality environment for output in a virtual reality headset.

Example 37 is at least one machine readable medium including instructions, which when executed by a computing system, cause the computing system to perform any of the methods of Examples 25-36.

Example 38 is an apparatus comprising means for performing any of the methods of Examples 25-36.

Example 39 is an apparatus, comprising: means for detecting, from image data of a real-world environment surrounding a human user, an object in the real-world environment; means for identifying, from the image data, a real-world location of the object in the real-world environment, relative to a viewing position; means for identifying a corresponding virtual location of the object for a scene of a virtual reality environment, wherein the corresponding virtual location is determined relative to the real-world location of the object in the real-world environment; means for displaying a virtual object at the corresponding virtual location in the scene of the virtual reality environment; and means for updating the display of the virtual object in the scene of the virtual reality environment, wherein the display of the virtual object is updated to correspond to movement of the viewing position in the real-world environment.

In Example 40, the subject matter of Example 39 optionally includes means for capturing the image data of the real-world environment, using an image sensor.

In Example 41, the subject matter of Example 40 optionally includes means for capturing depth data of the real-world environment, using a depth sensor, wherein the real-world location of the object is identified using the depth data and the image data.

In Example 42, the subject matter of any one or more of Examples 39-41 optionally include means for identifying characteristics of the virtual object to be displayed in the virtual reality environment, wherein the characteristics of the virtual object correspond to characteristics of the object in the real-world environment that are detected from the image data.

In Example 43, the subject matter of Example 42 optionally includes means for identifying a type of the virtual object to be displayed in the virtual reality environment based on the identified characteristics of the virtual object; wherein the means for displaying the virtual object includes a means for displaying a graphical representation of the object that is selected from one of a plurality of types of objects corresponding to the type of the virtual object.

In Example 44, the subject matter of any one or more of Examples 42-43 optionally include means for identifying a shape of the virtual object to be displayed in the virtual reality environment based on the identified characteristics of the virtual object; wherein the display of the virtual object includes displaying a graphical representation of the object that is modified based on the identified shape.

In Example 45, the subject matter of any one or more of Examples 39-44 optionally include wherein the means for displaying causes a display of the virtual object at the corresponding virtual location in response to the human user moving into a predefined area relative to the object in the real-world environment.

In Example 46, the subject matter of Example 45 optionally includes wherein the means for updating the display of the virtual object in the virtual reality environment further causes removal of the display of the virtual object in the virtual reality environment, in response to the human user moving out of the predefined area relative to the object in the real-world environment.

In Example 47, the subject matter of any one or more of Examples 39-46 optionally include means for transitioning a display of the virtual object to a display of a second virtual object, in response to user interaction with the virtual object in the virtual reality environment.

In Example 48, the subject matter of any one or more of Examples 39-47 optionally include means for animating the display of the virtual object in the virtual reality environment, in response to user interaction with the virtual object in the virtual reality environment.

In Example 49, the subject matter of any one or more of Examples 39-48 optionally include wherein the means for displaying includes a virtual reality headset, and wherein the virtual reality headset enables movement for the human user with six degrees of freedom.

In Example 50, the subject matter of any one or more of Examples 39-49 optionally include wherein the means for displaying generates the display of the virtual reality environment for output in a virtual reality headset.

Example 51 is a system configured to perform operations of any one or more of Examples 1-50.

Example 52 is a method for performing operations of any one or more of Examples 1-50.

Example 53 is a machine readable medium including instructions that, when executed by a machine cause the machine to perform the operations of any one or more of Examples 1-50.

Example 54 is a system comprising means for performing the operations of any one or more of Examples 1-50.

In the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment.

What is claimed is:

1. A device for generating location-customized content in a virtual reality environment presented to a human user, the device comprising:
processing circuitry; and
a storage device to store instructions that, when executed by the processing circuitry, cause the device to perform operations to:
detect, from image data of a real-world environment surrounding the human user, an object in the real-world environment;
identify, from the image data, a real-world location of the object in the real-world environment, relative to a viewing position of the human user;
identify a corresponding virtual location of the object for a scene of the virtual reality environment, wherein the corresponding virtual location is determined relative to the real-world location of the object in the real-world environment;
cause display of a virtual object at the corresponding virtual location in the scene of the virtual reality environment; and
cause update of the display of the virtual object in the scene of the virtual reality environment, wherein the display of the virtual object is updated to correspond to movement of the viewing position of the human user in the real-world environment.

2. The device of claim 1, further comprising:
camera circuitry, including an image sensor to capture the image data of the real-world environment.

3. The device of claim 2, the camera circuitry further including:
a depth sensor to capture depth data of the real-world environment, wherein the real-world location of the object is identified using the depth data and the image data.

4. The device of claim 1, the instructions further to cause the device to perform operations to:
identify characteristics of the virtual object to be displayed in the virtual reality environment, wherein the characteristics of the virtual object correspond to characteristics of the object in the real-world environment that are detected from the image data.

5. The device of claim 4, the instructions further to cause the device to perform operations to:
identify a type of the virtual object to be displayed in the virtual reality environment based on the identified characteristics of the virtual object;
wherein the display of the virtual object includes displaying a graphical representation of the object that is selected from one of a plurality of types of objects corresponding to the type of the virtual object.

6. The device of claim 4, the instructions further to cause the device to perform operations to:
identify a shape of the virtual object to be displayed in the virtual reality environment based on the identified characteristics of the virtual object;
wherein the display of the virtual object includes displaying a graphical representation of the object that is modified based on the identified shape.

7. The device of claim 1, wherein the display of the virtual object at the corresponding virtual location is caused in response to the human user moving into a predefined area relative to the object in the real-world environment.

8. The device of claim 7, wherein the update of the display of the virtual object in the virtual reality environment is followed by removal of the display of the virtual object in the virtual reality environment, in response to the human user moving out of the predefined area relative to the object in the real-world environment.

9. The device of claim 1, the instructions further to cause the device to perform operations to:
transition a display of the virtual object to a display of a second virtual object, in response to user interaction with the virtual object in the virtual reality environment.

10. The device of claim 1, the instructions further to cause the device to perform operations to:
animate the display of the virtual object in the virtual reality environment, in response to user interaction with the virtual object in the virtual reality environment.

11. The device of claim 1, wherein the device is a virtual reality headset, and wherein the virtual reality headset enables movement for the human user with six degrees of freedom.

12. The device of claim 1, wherein the device is a computing device that generates the display of the virtual reality environment for output in a virtual reality headset.

13. At least one machine readable storage medium, comprising a plurality of instructions adapted for generating location-customized content in a virtual reality environment presented to a human user, wherein the instructions, responsive to being executed with processor circuitry of a machine, cause the machine to perform operations that:
detect, from image data of a real-world environment surrounding the human user, an object in the real-world environment;
identify, from the image data, a real-world location of the object in the real-world environment, relative to a viewing position of the human user;
identify a corresponding virtual location of the object for a scene of the virtual reality environment, wherein the corresponding virtual location is determined relative to the real-world location of the object in the real-world environment;
cause display of a virtual object at the corresponding virtual location in the scene of the virtual reality environment; and
cause update of the display of the virtual object in the scene of the virtual reality environment, wherein the display of the virtual object is updated to correspond to movement of the viewing position of the human user in the real-world environment.

14. The machine readable storage medium of claim 13, wherein the image data of the real-world environment is captured by an image sensor.

15. The machine readable storage medium of claim 14, wherein the image data of the real-world environment includes depth data captured by a depth sensor, wherein the real-world location of the object is identified using the depth data and the image data.

16. The machine readable storage medium of claim 13, wherein the instructions further cause the machine to perform operations that:
identify characteristics of the virtual object to be displayed in the virtual reality environment, wherein the characteristics of the virtual object correspond to characteristics of the object in the real-world environment that are detected from the image data.

17. The machine readable storage medium of claim 16, wherein the instructions further cause the machine to perform operations that:
identify a type of the virtual object to be displayed in the virtual reality environment based on the identified characteristics of the virtual object;
wherein the display of the virtual object includes displaying a graphical representation of the object that is selected from one of a plurality of types of objects corresponding to the type of the virtual object.

18. The machine readable storage medium of claim 16, wherein the instructions further cause the machine to perform operations that:
identify a shape of the virtual object to be displayed in the virtual reality environment based on the identified characteristics of the virtual object,
wherein the display of the virtual object includes displaying a graphical representation of the object that is modified based on the identified shape.

19. The machine readable storage medium of claim 13, wherein the display of the virtual object at the corresponding virtual location is caused in response to the human user moving into a predefined area relative to the object in the real-world environment.

20. The machine readable storage medium of claim 19, wherein the update of the display of the virtual object in the virtual reality environment is followed by removal of the display of the virtual object in the virtual reality environment, in response to the human user moving out of the predefined area relative to the object in the real-world environment.

21. The machine readable storage medium of claim 13, wherein the instructions further cause the machine to perform operations that:
transition a display of the virtual object to a display of a second virtual object, in response to user interaction with the virtual object in the virtual reality environment.

22. The machine readable storage medium of claim 13, wherein the instructions further cause the machine to perform operations that:
animate the display of the virtual object in the virtual reality environment, in response to user interaction with the virtual object in the virtual reality environment.

23. A method of generating location-customized content in a virtual reality environment presented to a human user, the method comprising electronic operations performed with an electronic device, including:
detecting, from image data of a real-world environment surrounding the human user, an object in the real-world environment;
identifying, from the image data, a real-world location of the object in the real-world environment, relative to a viewing position of the human user;
identifying a corresponding virtual location of the object for a scene of the virtual reality environment, wherein the corresponding virtual location is determined relative to the real-world location of the object in the real-world environment;
displaying a virtual object at the corresponding virtual location in the scene of the virtual reality environment; and
updating the display of the virtual object in the scene of the virtual reality environment, wherein the display of the virtual object is updated to correspond to movement of the viewing position of the human user in the real-world environment.

24. The method of claim 23, the electronic operations further including:
capturing the image data of the real-world environment, using an image sensor; and
capturing depth data of the real-world environment, using a depth sensor, wherein the real-world location of the object is identified using the depth data and the image data.

25. The method of claim 23, the electronic operations further including:
identifying characteristics of the virtual object to be displayed in the virtual reality environment, wherein the characteristics of the virtual object correspond to characteristics of the object in the real-world environment that are detected from the image data.

26. The method of claim 25, the electronic operations further including:
identifying a type of the virtual object to be displayed in the virtual reality environment based on the identified characteristics of the virtual object;
wherein the display of the virtual object includes displaying a graphical representation of the object that is selected from one of a plurality of types of objects corresponding to the type of the virtual object.

27. The method of claim 25, the electronic operations further including:
identifying a shape of the virtual object to be displayed in the virtual reality environment based on the identified characteristics of the virtual object;
wherein the display of the virtual object includes displaying a graphical representation of the object that is modified based on the identified shape.
